(19) United States
(12) Patent Application Publication
(10) Pub. No.: US 2013/0215336 A1
(43) Pub. Date: Aug. 22, 2013

(54) LIGHTING DEVICE, DISPLAY DEVICE AND TELEVISION RECEIVING DEVICE

(71) Applicant: Hideki Miyata, Osaka (JP)

(72) Inventor: Hideki Miyata, Osaka (JP)

(73) Assignee: SHARP KABUSHIKI KAISHA, Osaka (JP)

(21) Appl. No.: 13/882,321

(22) PCT Filed: Nov. 2, 2011
(86) PCT No.: PCT/JP2011/075276

§ 371 Date: Apr. 29, 2013

(30) Foreign Application Priority Data
Nov. 9, 2010 (JP) 2010-251053

(51) Int. Cl. F21V 8/00; G02F 1/1335

(52) U.S. Cl. CPC G02B 6/002; G02F 1/133615
USPC 348/790; 362/608; 349/65

(57) ABSTRACT

An object of the present invention is to improve the rate at which light enters a display surface from an edge light-type lighting device and to improve the brightness of the display surface. A backlight device of the present invention is provided with: a light guide plate that has a light-receiving surface on a side face; and an LED light source 28 that is disposed so as to face the light-receiving surface of the light guide plate and covered by a lens 29. The lens 29 has a partially cylindrical shape, the cylinder axis thereof extending in the thickness direction of the light guide plate. Consequently, light leakage to the outside of the light guide plate in the thickness direction of the light guide plate can be prevented or mitigated. In addition, light can be diverged in a direction that is along the light-receiving surface of the light guide plate and perpendicular to the thickness direction of the light guide plate.

### TECHNICAL FIELD

The present invention relates to an illumination device, a display device, and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. Liquid crystal panels used in liquid crystal display devices do not emit light on their own, and therefore, it is necessary to provide a separate backlight device as an illumination device.

A known example of a conventional backlight device is an edge light-type backlight device in which a light-receiving surface is provided on the side face of a light guide plate, and a light source such as an LED is provided towards a side face of the light guide plate. Patent Document 1 discloses a conventional example of such an edge light-type backlight device. In a backlight device of Patent Document 1, an LED is covered by a concave lens with a hemispherical concavity that opens towards the light guide plate. Light emitted by the LED is transmitted through the concave lens, which converges the light at the light-receiving surface of the light guide plate, thus increasing the light-receiving efficiency of the light guide plate.

### RELATED ART DOCUMENT

### Patent Document

Patent Document 1: Japanese Patent Application Laid-Open Publication No. 2006-100575

### Problems to be Solved by the Invention

However, with the backlight device disclosed in Patent Document 1, light emitted by the LED is transmitted through the concave lens, which means that light from all directions to a light-receiving surface is converged at the light-receiving surface of the light guide plate. As a result, the light is not diverged in a direction that is perpendicular to the thickness direction of the light guide plate and along the light-receiving surface of the light guide plate, which means that it is not possible to have light enter a wide area of the light-receiving surface. As a result, it is not possible to increase the brightness of the display surface to a sufficient degree.

### SUMMARY OF THE INVENTION

The present invention was made taking into account the above-mentioned problem. An object of the present invention is to provide an illumination device that can improve the rate at which light enters the display surface and improve the brightness of the display surface.

### Means for Solving the Problems

The techniques disclosed in the present specification relate to an illumination device that includes: a light guide plate that has a light-receiving surface on a side face; and a light source disposed facing the light-receiving surface of the light guide plate and covered by a lens, wherein the lens has a partially cylindrical shape in which an axis thereof extends in a thickness direction of the light guide plate.

According to the above-mentioned illumination device, by forming a partially cylindrical lens in which the axis of the cylinder extends in the thickness direction of the light guide plate, the light emitted from the light source and transmitted through the lens is less susceptible to being diverged in the lens axis direction, or in other words, the thickness direction of the light guide plate. As a result, it is possible to prevent or mitigate the leakage of light to outside of the light guide plate in the thickness direction of the light guide plate. Also, as a result of a curved surface of a side face of the partially cylindrical lens, light emitted by the light source and transmitted through the lens is diverged in a direction that is perpendicular to the axis direction, or perpendicular to the thickness direction of the light guide plate and along the light-receiving surface of the light guide plate, which allows light to enter a wide area of the light-receiving surface. As a result, the rate of light entering the display surface from the illumination device can be improved, resulting in an improvement in the brightness of the display surface.

The lens may have an outline that is an arc in a plan view that protrudes towards the light-receiving surface.

According to this configuration, the outline of the lens forms an arc in a direction perpendicular to the thickness direction of the light guide plate and along the light-receiving surface of the light guide plate, which allows light emitted by the light source to be diverged in this direction.

The lens may have an outline with an angular shape in a side view that protrudes towards the light-receiving surface.

According to this configuration, the outline of the lens forms an angular shape in the thickness direction of the light guide plate, thus allowing light emitted from the light source to be converged in this direction.

The lens may have an outline that is rectangular in a front view with a short axis direction thereof being a thickness direction of the light guide plate.

According to this configuration, light emitted from the light source can be effectively diverged in the direction that is perpendicular to the thickness direction of the light guide plate and along the light-receiving surface of the light guide plate.

The lens may have an outline that is trapezoidal in a side view and protrudes towards the light-receiving surface.

According to this configuration, it is possible to control the degree to which light emitted by the light source is converged in the thickness direction of the light guide plate.

A top surface and a bottom surface of the lens with the partially cylindrical shape may each be given mirroring treatment. Alternatively, a reflective sheet may be bonded onto each of a top surface and a bottom surface of the lens with the partially cylindrical shape.

According to this configuration, of the light emitted from the light source, light that would otherwise pass through the top surface and bottom surface of the lens can be reflected, and thus, it is possible to increase the degree to which light emitted from the light source is converged in the thickness direction of the light guide plate.

A light distribution of light emitted from the light source and transmitted through the lens may be within a range of a thickness of the light guide plate, at the light-receiving surface.

According to this configuration, it is possible to prevent light from the light source from leaking out of the light guide plate along the thickness direction of the light guide plate.

The lens may have a curvature in a first direction along the thickness direction of the light guide plate such that light emitted from the light source and transmitted through the lens is converged in the first direction.

According to this configuration, by changing the curvature of the lens, it is possible to make the light distribution in the first direction even more narrow angle, and thus, it is possible to further increase the rate of light entering the display surface from the illumination device.

The lens may have a curvature in a second direction that is perpendicular to the thickness direction of the light guide plate and along the light-receiving surface of the light guide plate, such that light emitted from the light source and transmitted through the lens is diverged in the second direction.

According to this configuration, by changing the curvature of the lens, it is possible to make the light distribution in the second direction even more wide angle, and thus, it is possible to further increase the rate of light entering the display surface from the illumination device.

The illumination device may include a plurality of the aforementioned light sources, wherein respective light distributions along the second direction of light emitted from adjacent two of the aforementioned light sources and transmitted through the respective lenses of the respective light sources overlap at least partially at the light-receiving surface of the light guide plate.

According to this configuration, light from a plurality of light sources can enter the light-receiving surface of the light guide plate without any discontinuity in the second direction. As a result, it is possible to further increase the rate of light entering the display surface from the illumination device.

The techniques disclosed in the present specification can be expressed as a display device that includes a display panel that displays images using light from the above-mentioned illumination device. Also, a display device that uses a liquid crystal panel that uses liquid crystal as the display panel is novel and is useful. A television receiver that includes the above-mentioned display device is also novel and is useful. With the above-mentioned display device and television, it is possible to attain a greater area for the display region.

### Effects of the Invention

According to the techniques disclosed in the present specification, it is possible to provide an illumination device that can improve the rate of light entering the display surface and improve the brightness of the display surface.

### BRIEF DESCRIPTION OF THE DRAWINGS

FIG. 1 is an exploded perspective view of a television receiver TV according to Embodiment 1.

FIG. 2 is an exploded perspective view of a liquid crystal display device 10.

FIG. 3 is a cross-sectional view of the liquid crystal display device 10.

FIG. 4 is a magnified cross-sectional view of an LED light source 28, a lens 29, and a light-receiving surface 20a.

FIG. 5 is a magnified plan view of the LED light source 28, the lens 29, and the light-receiving surface 20a.

FIG. 6 is a front view of the LED light source 28 and the lens 29.

FIG. 7 is a perspective view of the LED light source 28 and the lens 29.

FIG. 8 is a magnified cross-sectional view of an LED light source 128, a lens 129, and a light-receiving surface 120a of a liquid crystal display device according to Embodiment 2.

FIG. 9 is a front view of the LED light source 128 and the lens 129.

FIG. 10 is a perspective view of the LED light source 128 and the lens 129.

### DETAILED DESCRIPTION OF EMBODIMENTS

### Embodiment 1

Embodiment 1 will be described with reference to the drawings. Each of the drawings indicates an X axis, a Y axis, and a Z axis in a portion of the drawings, and each of the axes indicates the same direction for the respective drawings. The Y axis direction corresponds to the vertical direction and the X axis direction corresponds to the horizontal direction. Unless otherwise noted, “up” and “down” in the description is based on the vertical direction.

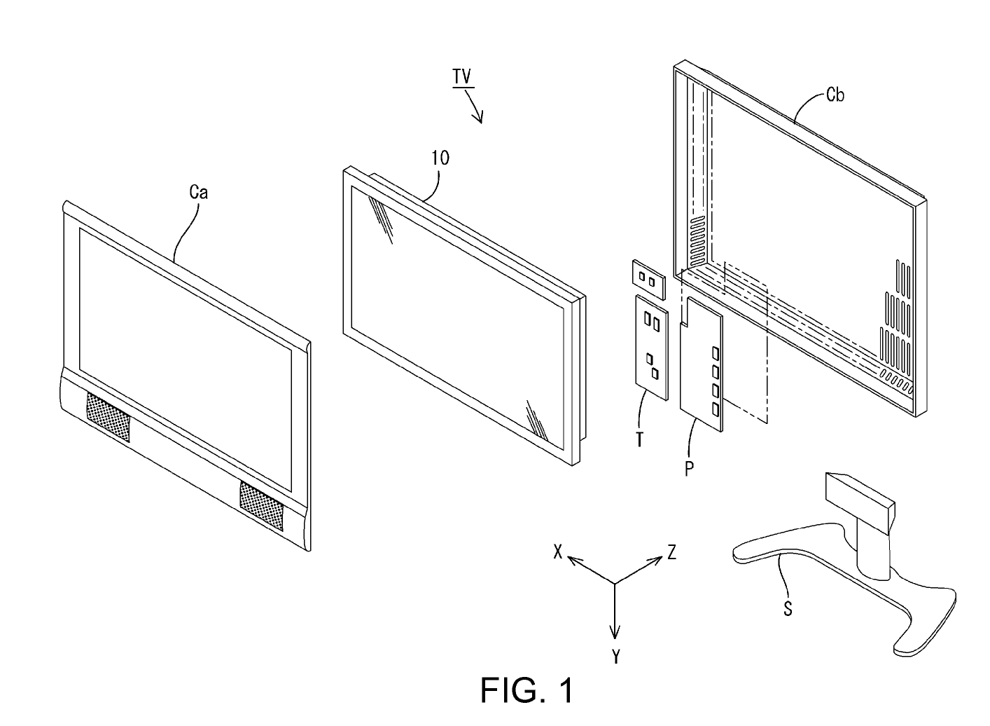

FIG. 1 is an exploded perspective view of a television receiver TV according to Embodiment 1. The television receiver TV includes a liquid crystal display device 10, front and rear cabinets Ca and Cb that store the display device D therebetween, a power source P, a tuner T, and a stand S.

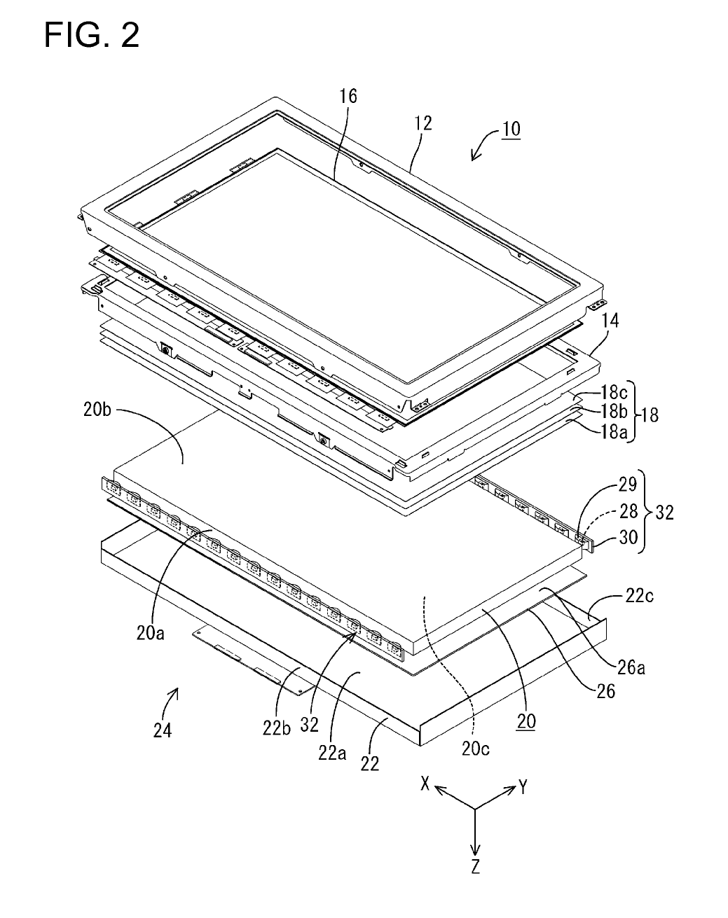

FIG. 2 is an exploded perspective view of the liquid crystal display device 10. The upper side of FIG. 2 is the front side, and the lower side is the rear side. As shown in FIG. 2, the liquid crystal display device 10 as a whole has a rectangular shape with a longer horizontal direction, includes a liquid crystal panel 16, which is a display panel, and a backlight device 24, which is an external light source, and is held together integrally with a frame-shaped bezel 12 or the like.

Next, the liquid crystal panel 16 will be described. In the liquid crystal panel 16, a pair of transparent (having a high light transmission) glass substrates are bonded together with a prescribed gap therebetween, and a liquid crystal layer (not shown in drawings) is sealed between the glass substrates. One of the glass substrates is provided with switching elements (TFTs, for example) that are connected to source wiring lines and gate wiring lines that intersect perpendicularly with each other, pixel electrodes connected to the switching elements, an alignment film, and the like, and the other glass substrate is provided with color filters made of colored portions of R (red), G (green), B (blue), and the like that are disposed with a prescribed arrangement, an opposite electrode, an alignment film, and the like. Of these, the source wiring lines, the gate wiring lines, the opposite electrode, and the like are supplied with image data and various control signals necessary in order to display images from a driver circuit substrate that is not shown in drawings. Polarizing plates (not shown in drawings) are disposed outside of the glass substrates.

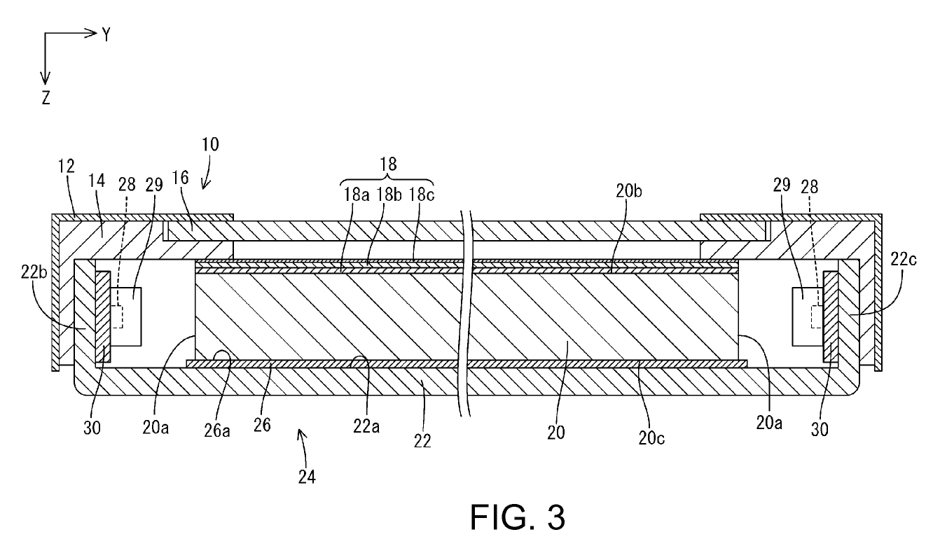

Next, the backlight device 24 will be described. FIG. 3 is a cross-sectional view that shows a cross-section of the liquid crystal display device 10 along the vertical direction (Y axis direction). As shown in FIGS. 2 and 3, the backlight device 24 includes a frame 14, optical members 18, and a backlight chassis 22. The frame 14 has a frame shape and supports the liquid crystal panel 16 along an inner edge thereof. The optical members 18 are placed on the front side (side of the light-emitting surface 20b) of the light guide plate 20. The backlight chassis 22 has a substantially box shape that is open on the front side (light-emitting side/liquid crystal panel 16 side).

A pair of LED (light emitting diode) units 32 and 32, a reflective sheet 26, and a light guide plate 20 are stored inside the backlight chassis 22. The LED units 32 are disposed on the long-side outer edges (side walls) 22b and 22c of the backlight chassis 22, and emit light. Lengthwise direction side faces (light-receiving surface) 20a of the light guide plate 20 are disposed at positions facing the LED units 32, and guide light emitted from the LED units 32 towards the liquid crystal panel 16. The optical members 18 are placed on the front side of the light guide plate 20. In the backlight device 24 according to the present embodiment, the light guide plate 20 and the optical members 18 are disposed directly below the liquid crystal panel 16, and the LED units 32, which are the light sources, are disposed on side edges of the light guide plate 20, this configuration being the edge light type (side light type).

The backlight chassis 22 is made of a metal such as an aluminum-type material, for example, and is constituted of a bottom plate 22a that is rectangular in a plan view, side walls 22b and 22c that rise from the outer edges of the respective long sides of the bottom plate 22a, and side walls that rise from the outer edges of the respective short sides of the bottom plate 22a. The space inside the backlight chassis 22 between the LED units 32 is the storage space for the light guide plate 20. On the rear side of the bottom plate 22a, a power source circuit board (not shown in drawings) that supplies power to the LED units 32, and the like are installed.

The optical members 18 include a diffusion sheet 18a, a lens sheet 18b, and a reflective polarizing plate 18c layered in this order from the light guide plate 20. The diffusion sheet 18a, the lens sheet 18b, and the reflective polarizing plate 18c function to convert the light emitted from the LED units 32 and transmitted through the light guide plate 20 into planar light. The liquid crystal panel 16 is disposed on the upper side of the reflective polarizing plate 18d, and the optical members 18 are disposed between the light guide plate 20 and the liquid crystal panel 16.

The LED unit 32 has a configuration in which the LED light sources 28, which emit white light, are aligned in a row on a rectangular LED substrate 30, which is made of resin. Each LED light source 28 is covered by a lens 29 that can transmit light emitted from the LED light source 28. As shown in FIG. 2, each lens 29 has a partially cylindrical shape in which the axis thereof extends in the thickness direction (Z axis direction) of the light guide plate 20. The LED substrates 30 are fixed to the side walls 22b and 22c of the backlight chassis 22 by screws or the like. The LED light source 28 may be made of a blue light emitting element coated with a fluorescent material that has a light emitting peak in the yellow region so as to emit white light. The LED light source 28 may alternatively be made of a blue light emitting element coated with fluorescent materials that have light emitting peaks in the green region and the red region, respectively, so as to emit white light. The LED light source 28 may also be made of a blue light emitting element coated with a fluorescent material that has a light emitting peak in the green region, combined with a red light emitting element, so as to emit white light. The LED light source 28 may also be made of a combination of a blue light emitting element, a green light emitting element, and a red light emitting element, so as to emit white light. The LED light source 28 may also combine an ultraviolet light emitting element with fluorescent materials. In particular, the LED light source 28 may be made of an ultraviolet light emitting element coated with fluorescent materials that have light emitting peaks in the blue, green, and red regions, respectively, so as to emit white light.

The reflective sheet 26 is made of a synthetic resin and the surface thereof has a white color with excellent light-reflective properties, and is placed on the front side of the bottom plate 22a of the backlight chassis 22. The reflective sheet 26 has a reflective surface on the front side thereof, and the reflective surface is in contact with an opposite surface 20c of the light guide plate 20, thus allowing light that leaks from the LED units 32 and 32 or from the light guide plate 20 to the opposite surface 20c to be reflected.

The light guide plate 20 is a rectangular plate-shaped member formed of a resin of acrylic or the like with a high transmission (high transparency), and is in contact with the reflective sheet 26 and supported by the backlight chassis 22. As shown in FIG. 2, the light guide plate 20 is disposed between the LED units 26 and one of the side walls 22c of the backlight chassis 22, such that the light emitting surface 20b, which is the main plate surface, faces the diffusion sheet 18a, and the opposite surface 20c, which is on a side opposite to the light emitting surface 20b, faces the reflective sheet 26. By providing such a light guide plate 20, light emitted from the LED units 32 enters the light-receiving surfaces 20a of the light guide plate 20 and is emitted from the light emitting surface 20b facing the diffusion sheet 18a, thus illuminating the liquid crystal panel 16 from the rear.

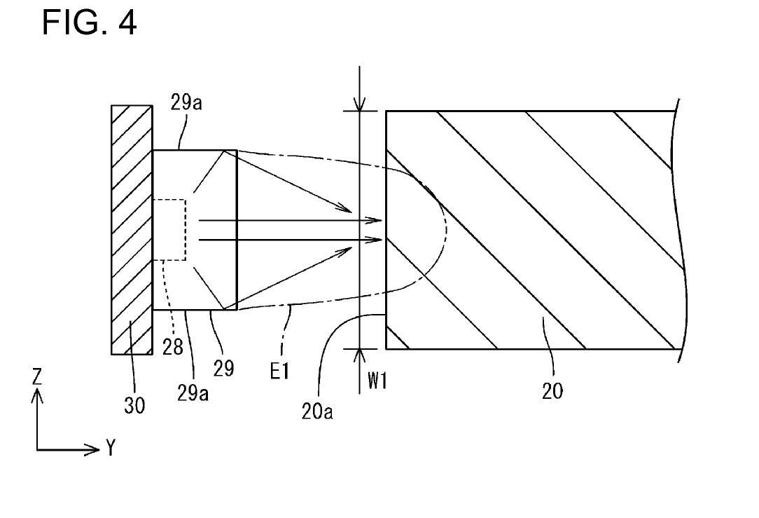

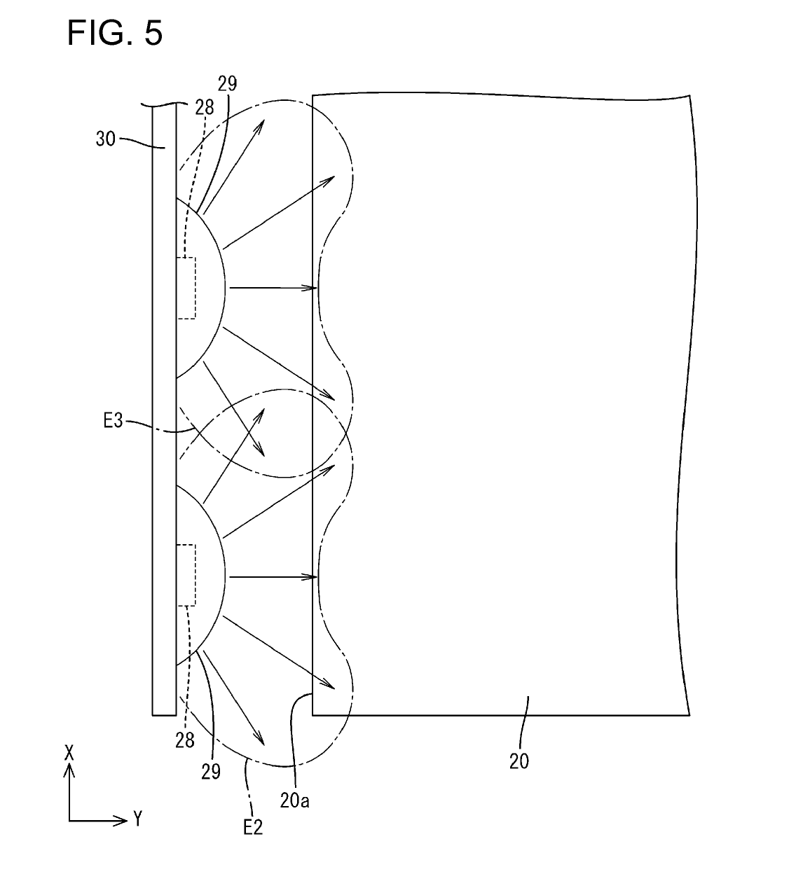

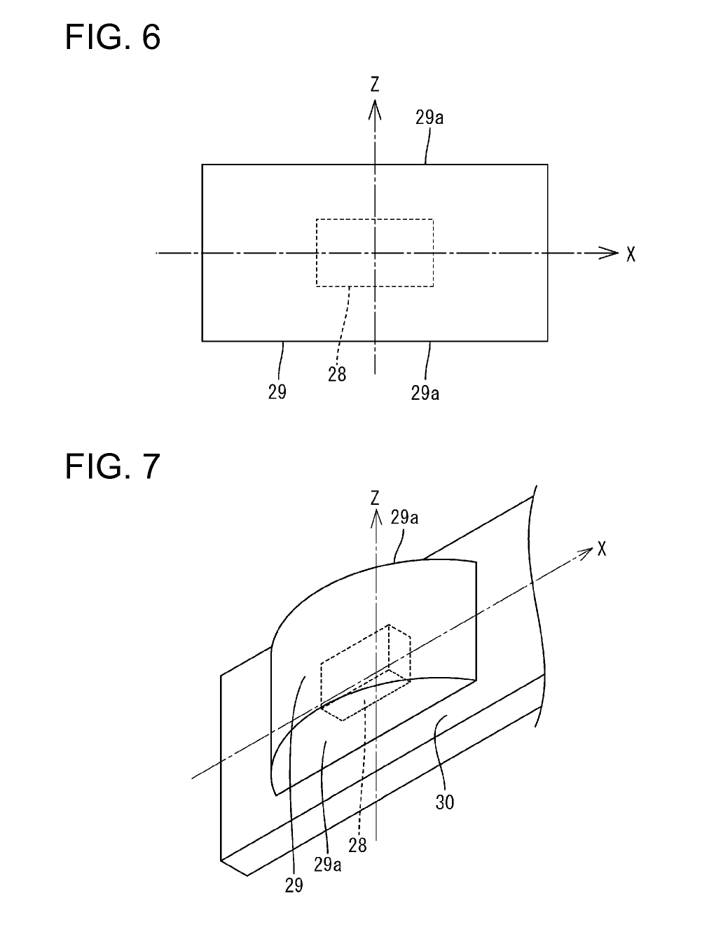

Next, the shape of the lenses 29, which cover the LED light sources 28, and the light distribution properties of light emitted from the LED light sources 28 and transmitted through the lenses 29 will be described. FIG. 4 is a magnified cross-sectional view of the LED light source 28, the lens 29, and a vicinity of the light-receiving surface 20a of the light guide plate 20. FIG. 5 is a magnified plan view of the LED light source 28, the lens 29, and a vicinity of the light-receiving surface 20a of the light guide plate 20. FIG. 6 is a front view of the LED light source 28 and the lens 29. FIG. 7 is a perspective view of the LED light source 28 and the lens 29.

As shown in FIG. 4, the lens 29 has an outline with an angular shape (rectangular in the present embodiment) in a side view that protrudes towards the light-receiving surface 20a of the light guide plate 20. By providing the lens 29 with such a shape, the curvature of the lens 29 in the thickness direction (Z axis direction) of the light guide plate 20 is such that light emitted from the LED light source 28 and transmitted through the lens 29 is converged in the Z axis direction. Specifically, a light distribution E1 along the Z axis direction is converged so as to gather within a thickness W1 range of the light guide plate 20 in the Z axis direction, which prevents light emitted from the LED light source 28 from leaking outside the light guide plate 20 in the Z direction.

The top surface and bottom surface of the lens 29 both receive mirroring treatment, and thus, the top surface and the bottom surface of the lens 29 are respectively mirrored surfaces 29a. As a result, light emitted from the LED light source 28 towards the top surface and the bottom surface of the lens 29 is reflected at the top surface and the bottom surface, respectively, as shown in FIG. 4, and converged at the light-receiving surface 20a of the light guide plate 20 in the thickness direction of the light guide plate 20.

On the other hand, as shown in FIG. 5, the lens 29 has an outline that is an arc that protrudes towards the light-receiving surface 20a in a plan view. By forming the lens 29 in this shape, the curvature thereof in the direction that is perpendicular to the thickness direction of the light guide plate 20 and along the light-receiving surface 20a of the light guide plate 20 (X axis direction) is such that the light emitted from the LED light source 28 and transmitted through the lens 29 is diverged in the X axis direction. Specifically, as shown in FIG. 5, light distributions E2 and E3 along the X axis direction are such that light from adjacent LED light sources 28 partially overlaps in the X axis direction. In other words, in the backlight device 24, the light emitted from the LED light source 28 and transmitted through the lens 29 enters the light-receiving surface 20a of the light guide plate 20 without any discontinuity in the X axis direction, allowing light to enter more efficiently.

As shown in FIG. 6, the lens 29 has a rectangular outline in a front view in which the short axis direction is the thickness direction (Z axis direction) of the light guide plate 20. Thus, the lens 29 has a shape such that light emitted from the LED light source and transmitted through the lens 29 is effectively diverged in the long axis direction of the outline of the rectangular lens 29 from the front view, or in other words, the X axis direction.

In the above-mentioned backlight device 24 of the present embodiment, by providing the lens 29 with a partial cylindrical shape in which the axis thereof extends in the thickness direction of the light guide plate 20, light emitted from the LED light source 28 and transmitted through the lens 29 is not susceptible to being diverged in the axis direction of the lens 29, or in other words, the thickness direction of the light guide plate 20. As a result, it is possible to prevent or mitigate the leakage of light to outside the light guide plate 20 in the thickness direction thereof. In addition, the curved surface of the side face of the lens 29 with a partial cylindrical shape causes light emitted from the LED light source 28 and transmitted through the lens 29 to be diverged in the direction that is perpendicular to the cylinder axis direction or the direction that is perpendicular to the thickness direction of the light guide plate 20 and along the light-receiving surface 20a of the light guide plate 20, allowing light to enter a wide area of the light-receiving surface 20a. As a result, the rate of light entering the display surface of the liquid crystal panel 16 from the backlight device 24 can be improved, which results in an improvement in the brightness of the display surface.

In the backlight device 24 of the present embodiment, the lens 29 has an outline that is an arc that protrudes towards the light-receiving surface 20a in a plan view. As a result, light emitted from the LED light source 28 can be diverged in the X axis direction.

In the backlight device 24 of the present embodiment, the lens 29 has a rectangular outline in a side view that protrudes towards the light-receiving surface 20a. As a result, light emitted from the LED light source 28 can be converged in the Z direction.

In the backlight device 24 of the present embodiment, the lens 29 has an outline with a rectangular shape in a front view in which the thickness direction of the light guide plate 20 is the short axis direction. As a result, light emitted from the LED light source 28 can be effectively diverged in the direction that is perpendicular to the thickness direction of the light guide plate 20 and along the light-receiving surface of the light guide plate 20.

In the backlight device 24 of the present embodiment, the top surface and bottom surface of the lens 29 with a partially cylindrical shape are each given mirroring treatment, thus forming respective mirrored surfaces 29a. As a result, it is possible to reflect light emitted from the LED light source 28 that would otherwise be transmitted through the top surface and the bottom surface of the lens 29, thus increasing the degree to which light emitted from the LED light source 28 is converged in the thickness direction of the light guide plate 20.

In the backlight device 24 of the present embodiment, the curvature of the lens 29 in the Z axis direction (thickness direction of the light guide plate 20) is such that the light emitted from the LED light source 28 and transmitted through the lens 29 is converged in the Z direction. As a result, the light distribution in the X axis direction can be made narrower angle, and the rate of light entering the display surface of the liquid crystal panel 16 from the backlight device 24 can be further improved.

In the backlight device 24 of the present embodiment, the curvature of the lens 29 along the X axis direction (direction that is perpendicular to the thickness direction of the light guide plate 20 and along the light-receiving surface 20a of the light guide plate 20) may be such that the light emitted from the LED light source 28 and transmitted through the lens 29 is diverged in the X axis direction. With this configuration, by changing the curvature of the lens 29, the light distribution in the X axis direction can be made wider angle, and the rate of light entering the display surface of the liquid crystal panel 16 from the backlight device 24 can be further improved.

The backlight device 24 of the present embodiment includes a plurality of LED light sources 28, and the light distributions along the X axis direction of light emitted by adjacent LED light sources 28 and transmitted through the lenses 29 partially overlap in the light-receiving surface 20a of the light guide plate 20. As a result, light from the plurality of LED light sources 28 can enter the light-receiving surface 20a of the light guide plate 20 without any discontinuity in the X axis direction, and the rate of light entering the display surface of the liquid crystal panel 16 from the backlight device 24 can be further improved.

### Embodiment 2

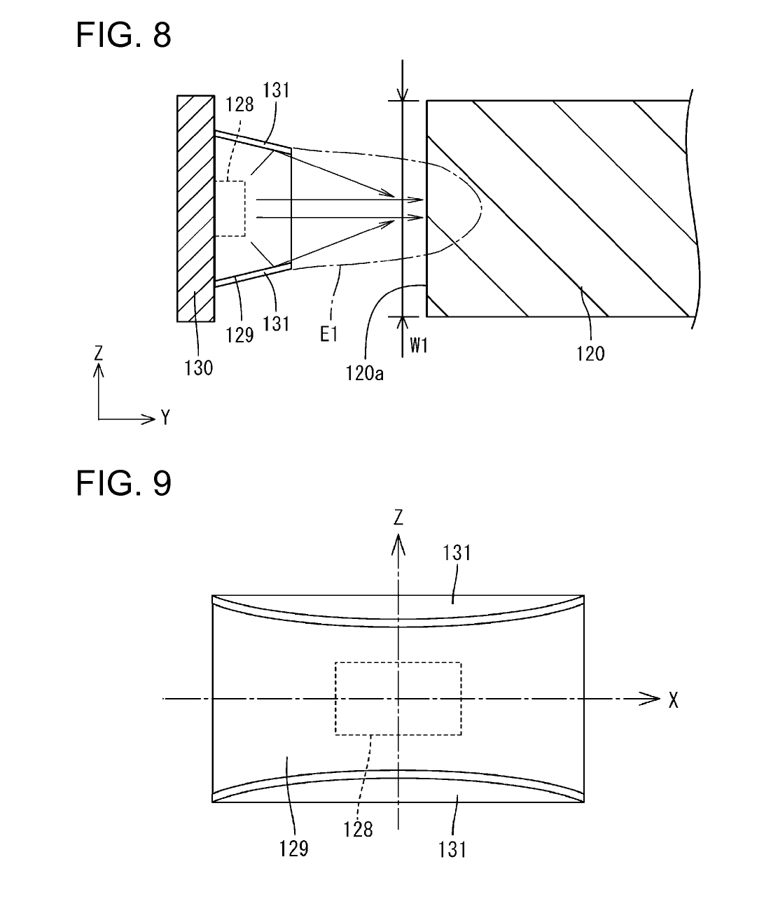

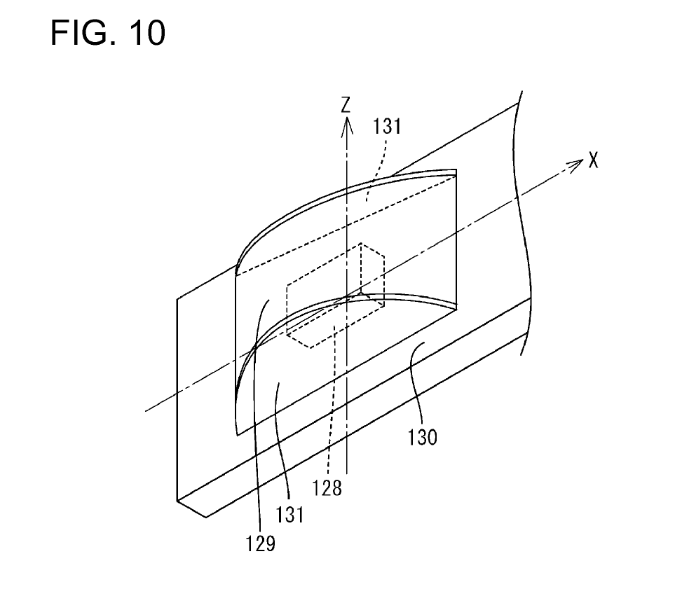

Embodiment 2 will be described with reference to the drawings. FIG. 8 is a magnified cross-sectional view of an LED light source 128, a lens 129, and a light-receiving surface 120a of a liquid crystal display device according to Embodiment 2. FIG. 9 is a front view of the LED light source 128 and the lens 129. FIG. 10 is a perspective view of the LED light source 128 and the lens 129. Embodiment 2 differs from Embodiment 1 in configuration and shape of the top surface and bottom surface of the lens 129. Other configurations are similar to those of Embodiment 1, and therefore, descriptions of the configurations, operation, and effect will be omitted. Parts in FIGS. 8, 9, and 10 that have 100 added to the reference characters of FIGS. 4, 6, and 7 are the same as these parts described in Embodiment 1.

In the backlight device of Embodiment 2, as shown in FIG. 8, the lens 129 has a trapezoidal outline that protrudes towards a light-receiving surface 120a in a side view. In other words, the top surface of the lens 129 is inclined downward in the Z axis direction and the bottom surface of the lens 129 is inclined upward in the Z axis direction. With the lens 129 having this shape, light emitted from the LED light source 128 and transmitted through the lens 129 can be more converged in the Z axis direction. Also, by changing the angle of incline of the top surface and bottom surface of the lens 129 in this manner, it is possible to control the degree to which light emitted from the LED light source 128 is converged in the Z axis direction.

In the backlight device of Embodiment 2, as shown in FIGS. 9 and 10, reflective sheets 131 are bonded respectively to the top surface and the bottom surface of the lens 129, which has a partially cylindrical shape. With this configuration, as shown in FIG. 8, light emitted from the LED light source 128 towards the top surface and the bottom surface of the lens 129 is reflected off of the top surface and the bottom surface, respectively, and is converged at the light-receiving surface 120a of the light guide plate 120 in the thickness direction thereof. As a result, it is possible to increase the degree to which light emitted from the LED light source 28 is converged in the thickness direction of the light guide plate 20.

The corresponding relation between the configurations of each embodiment and the configurations of the present invention will be described. The LED light sources 28 and 128 are examples of a “light source”. The Z axis direction is an example of a “first direction”. The X axis direction is an example of a “second direction”. The backlight device 24 is an example of an “illumination device”.

Modification examples of each of the above embodiments will be described below.

(1) In each embodiment above, the lens had a rectangular outline in a front view in which the thickness direction of the light guide plate was the short axis direction, but the outline of the lens in a front view may be square, or the outline of the lens in a front view may be rectangular with the long axis direction being the thickness direction of the light guide plate.

(2) In each embodiment above, a liquid crystal display device using a liquid crystal panel as a display panel was described, but the present invention is applicable to a display device that uses another type of display panel.

(3) In each embodiment above, a television receiver that includes a tuner was described, but the present invention is applicable to a display device without a tuner.

Embodiments of the present invention were described above in detail, but these are merely examples, and do not limit the scope defined by the claims. The technical scope defined by the claims includes various modifications of the specific examples described above.

Also, the technical elements described in the present specification or shown in the drawings realize technical utility each on their own or through a combination of various technical elements, and are not limited to the combinations defined by the claims at the time of filing. Also, the techniques described in the present specification or shown in the drawings can accomplish a plurality of objects simultaneously, and each one of the objects on its own has technical utility.

### DESCRIPTION OF REFERENCE CHARACTERS

TV television receiver
Ca, Cb cabinet
T tuner
S stand
10 liquid crystal display device
12 bezel
14 frame
16 liquid crystal panel
18 optical member
18a diffusion sheet
18b lens sheet
18c reflective polarizing plate
20, 120 light guide plate
20a, 120a light-receiving surface
22 backlight chassis
22a bottom plate
24 backlight device
26, 131 reflective sheet
28, 128 LED light source
29, 129 lens
29a mirrored surface
30, 130 LED substrate
32 LED unit

1: An illumination device, comprising:
a light guide plate that has a light-receiving surface on a side face; and
a light source disposed facing the light-receiving surface of the light guide plate and covered by a lens,
wherein the lens has a partially cylindrical shape in which an axis thereof extends in a thickness direction of the light guide plate.

2: The illumination device according to claim 1, wherein the lens has an outline that is an arc in a plan view that protrudes towards the light-receiving surface.

3: The illumination device according to claim 1, wherein the lens has an outline with an angular shape in a side view that protrudes towards the light-receiving surface.

4: The illumination device according to claim 1, wherein the lens has an outline that is rectangular in a front view with a short axis direction thereof being a thickness direction of the light guide plate.

5: The illumination device according to claim 1, wherein the lens has an outline that is trapezoidal in a side view and protrudes towards the light-receiving surface.

6: The illumination device according to claim 1, wherein a top surface and a bottom surface of the lens with the partially cylindrical shape are each given mirroring treatment.

7: The illumination device according to claim 1, wherein a reflective sheet is bonded onto each of a top surface and a bottom surface of the lens with the partially cylindrical shape.

8: The illumination device according to claim 1, wherein a light distribution of light emitted from the light source and transmitted through the lens is within a range of a thickness of the light guide plate, at the light-receiving surface.

9: The illumination device according to claim 1, wherein the lens has a structure such that light emitted from the light source and transmitted through the lens is converged in a first direction along the thickness direction of the light guide plate.

10: The illumination device according to claim 1, wherein the lens has a curvature in a cross-section thereof on a plane perpendicular to the thickness direction of the light guide plate such that light emitted from the light source and transmitted through the lens is diverged in a second direction perpendicular to the thickness direction of the light guide plate.

11: The illumination device according to claim 10, comprising a plurality of said light sources,
wherein respective light distributions along the second direction of light emitted from adjacent two of said light sources and transmitted through the respective lenses of the respective light sources overlap at least partially at the light-receiving surface of the light guide plate.

12: A display device, comprising a display panel that displays images using light from the illumination device according to claim 1.

13: The display device according to claim 12, wherein the display panel is a liquid crystal panel that uses liquid crystal.

14: A television receiver, comprising the display device according to claim 12.
